(19) United States
(12) Patent Application Publication
(10) Pub. No.: US 2017/0211012 A1
(43) Pub. Date: Jul. 27, 2017

(54) METHOD OF EXTRACTING LIPIDS FROM MICROBES

(71) Applicant: University of Maryland, Baltimore, Baltimore, MD (US)

(72) Inventors: Robert ERNST, Silver Spring, MD (US); David GOODLETT, Baltimore, MD (US); Daniel POWELL, Oro Valley, AZ (US)

(73) Assignee: University of Maryland, Baltimore, Baltimore, MD (US)

(21) Appl. No.: 15/118,338

(22) PCT Filed: Feb. 17, 2015
(86) PCT No.: PCT/US15/16133

§ 371 Date: Aug. 11, 2016

Related U.S. Application Data
(60) Provisional application No. 61/940,674, filed on Feb. 17, 2014.

(51) Int. Cl. C11B 1/10; C11B 1/02

(52) U.S. Cl. CPC C11B 1/10; C11B 1/025

(57) ABSTRACT

Improved methods for extracting lipid-containing molecules from microbes are disclosed. The methods utilize selected surfactants for extraction of lipids and lipopolysaccharides from microbes, such as bacteria and fungi. The extracted lipids and lipopolysaccharides may be used, for example, to identify the source microbe via mass spectroscopy.

### STATEMENT OF FEDERALLY SPONSORED RESEARCH AND DEVELOPMENT

This invention was made with government support under Grant Number GM111066 awarded by The National Institutes of Health. The government has certain rights in the invention.

### TECHNICAL FIELD

The present invention generally relates to improved methods for extracting lipid-containing molecules from microbes, such as bacteria and fungi. More specifically, the present invention is related to methods of utilizing selected surfactants for extraction of lipids and lipopolysaccharides from bacteria and fungi. The extracted lipids and lipopolysaccharides may be used, for example, to identify the source bacteria and fungi via mass spectroscopy.

### BACKGROUND OF INVENTION

Rapid and accurate identification of microbes, such as bacteria and fungi of medical importance, is needed to allow physicians to react and respond appropriately to infections, including those that are potentially life threatening. Such identification commonly requires culture on solid medium or growth in liquid media under specific conditions of atmosphere, heat and humidity, followed by diagnostic analysis that may require additional rounds of replication in culture or purification of specific bacterial or fungal products. At best, bacterial and fungal identification requires many days during which patient health can be difficult to maintain or even rapidly deteriorate while the causative agent of the illness is ascertained. Thus, improved methods for bacterial and fungal identification are needed.

New techniques for microbe identification have been developed that utilize mass spectrometric characterization of bacterial and fungal lipids and proteins. Mass spectrometry is an analytical technique that measures the mass-to-charge ratio of charged particles, and can be used for determining the elemental composition of a sample or molecule and elucidating the chemical structures of molecules. For example, one promising technique is based on obtaining precursor ion mass spectrometry (PIMS) spectra on precursor ions of lipids in a sample of bacteria and fungi, and comparing the obtained spectra to previously prepared lipid spectral databases. This technique can be used, for example, to distinguish bacteria, to distinguish antibiotic vs. non-antibiotic resistant strains of bacteria, and to identify bacterial environmental variants. Details regard the technique can be found in U.S. Application Publication No. 2012/0197535, for example. Other relevant techniques include those provided in U.S. Pat. No. 8,415,619.

One of the bacterial lipids used in mass spectrometric characterization is lipid A, the endotoxic portion of lipopolysaccharide (LPS). Lipid A is embedded in the outer leaflet of the Gram-negative bacterial outer membrane. As an essential component of Gram-negative bacterial membranes, the lipid exhibits species-specific structural diversity. The general structure consists of a backbone of two glucosamine residues present as a β-(1-6)-linked dimer. This backbone can be diversified in response to specific environmental signals or between bacterial species. Specifically, changes in the fatty acid content varying both in the length and number of fatty acid side chains (e.g. tetra-to hepta-acylated) and phosphorylation patterns can differ as well. Additional modifications of the phosphate residues by monosaccharides, such as aminoarabinose or galactosamine and phosphoethanolamine can occur. The diversity of such species and environmentally-driven structural modifications are an adaptive mechanism that increases bacterial survival often through increasing resistance to host antimicrobial peptides, or in the avoidance of the host innate immune system. Precursor molecules (i.e., molecules from which LA is cleaved during isolation) to LA include, but are not limited to LPS. Use of mass spectrometric characterization to identify bacteria takes advantages of the species-specific composition of lipid A to use the molecule in the identification of bacteria.

While methods for extracting lipid A from bacteria are known, techniques such as the hot phenol-water extraction procedure of Westphal and Lüderitz (Angew. Chem. 66: 407-417 (1954)) can require several days (3-7 days) simply to isolated LPS or endotoxins from the Gram (−) bacteria, with further steps required to isolate the lipid A moiety. New methods have been described to extract LPS from small quantities of cells, such as by mini-phenol extraction (Li, J. P. et al. J. Chromatogr. A. 817: 325-336 (1988)) or using an RNA-isolating reagent, but these methods still require two or three days, and they use the caustic chemical phenol (Yi, C. E. and M. Hackett. Analyst. 125: 651-656 (2000)). Methods using mineral acid hydrolysis can be used to release lipid A from endotoxins, however such methods involve modification to the lipid A molecule which makes the use of the molecule as a molecular signature problematic. Moreover, many of the current techniques do not yield LPS fractions that are suitable for mass spectroscopy.

In order to fully realize the potential of mass spectrometric characterization for identification of bacteria and fungi, improved methods for lipid extraction from bacteria and fungi are needed. The present invention is directed to these and other important goals.

### BRIEF SUMMARY OF INVENTION

The present invention generally relates to an improved method for obtaining lipid molecules from microbial cells using surfactant-based extraction methods. The extracted lipids can be used, for example, in means of identifying the microbe from which they were obtained, through such techniques as mass spectrometric characterization, in particular, the PIMS spectra technique disclosed in U.S. Application Publication No. 2012/0197535, the entire content of which is incorporated herein by referenced. Other relevant mass spectrometry techniques include those provided in U.S. Pat. No. 8,415,619, the entire content of which is incorporated herein by referenced.

It will be appreciated that the manner in which the lipids obtained using the methods of the present invention may be utilized is not limited to methods associated with bacterial and fungal identification or mass spectrometry. Indeed, it will be readily appreciated that the lipids obtained using the methods of the present invention may be utilized in a wide variety of manners that need not be catalogued herein.

The methods for obtaining lipid molecules from microbial cells using surfactant-based extraction methods disclosed in the present application include (i) methods where microbial cells are pre-treated with a surfactant prior to lipid extraction, and (ii) methods where the surfactant is included in the steps of lipid extraction. Both types of methods are summarized below.

As indicated above, the present invention includes methods for obtaining lipid molecules from microbial cells where the cells are pre-treated with a surfactant prior to lipid extraction. Thus, and in a first embodiment, the invention is drawn to a method of obtaining lipids from a microbe comprising (a) mixing microbial cells with a surfactant to form a suspension, and (b) extracting lipids from the suspension.

In a second embodiment, the invention is drawn to a method of obtaining lipids from a microbe comprising (a) mixing microbial cells with a surfactant to form a suspension, and (b) extracting lipids from the suspension using a lysing agent.

In a third embodiment, the invention is drawn to a method of obtaining lipids from a microbe comprising (a) mixing microbial cells with a surfactant to form a suspension, and (b) extracting lipids from the suspension using an ammonium-isobutyric acid lysing agent.

In each of these embodiments, the microbe may be a bacterium, a fungus, or a mixture of both. In one aspect, the microbe is a gram-negative bacterium. In one aspect, the microbe is a gram-positive bacterium.

In each of these embodiments, step (a) may further comprise one or more of: (i) incubating the suspension for a period of time of between about 1 and 60 minutes, (ii) incubating the suspension at a temperature of between about 25° C. and 45° C., and (iii) shaking the suspension on a rotating platform set at between about 50 and 200 rpm. In one aspect, step (a) further comprises (i) and (ii), or (i) and (iii), or (ii) and (iii), or each of (i), (ii) and (iii). In one aspect of (i), the suspension is incubated for about 30 minutes. In one aspect of (ii), the temperature is about 37° C. In one aspect of (iii), the suspension is shaken on a rotating platform set at about 125 rpm.

In each of these embodiments, step (a) may further comprise one or more of: (i) incubating the suspension for a period of time of about 30 minutes, (ii) incubating the suspension at a temperature of about 37° C., and (iii) shaking the suspension on a rotating platform set at about 125 rpm. In one aspect, step (a) further comprises (i) and (ii), or (i) and (iii), or (ii) and (iii), or each of (i), (ii) and (iii).

In the second and third embodiments, step (b) may further comprise one or more of: (i) harvesting microbial cells from the suspension of (a), and (ii) treating the cells from the suspension of (a) with the lysing agent under conditions of a temperature of between about 80° C. and 120° C. for a period of time of about 10 to 120 minutes, followed by centrifugation of the treated cells and harvesting of the supernatant. In one aspect, step (b) further comprises both (i) and (ii). In one aspect of (ii), the cells are treated with the lysing agent under conditions of a temperature of between about 100° C. for a period of time of about 60 minutes. In another aspect of (ii), the lysing agent is a mixture of ammonia hydroxide and isobutyric acid. In a further aspect of (ii), the supernatant is lyophilized to form a powder, the powder is washed with a first solvent, and the powder is extracted with a second solvent.

In the second and third embodiments, step (b) may further comprise one or more of: (i) harvesting microbial cells from the suspension of (a), and (ii) treating the cells from the suspension of (a) with ammonia hydroxide and isobutyric acid as a lysing agent under conditions of a temperature of about 100° C. for a period of time of about 60 minutes, followed by centrifugation of the treated cells and harvesting of the supernatant. In one aspect, step (b) further comprises both (i) and (ii). In a further aspect of (ii), the supernatant is lyophilized to form a powder, the powder is washed with a first solvent, and the powder is extracted with a second solvent.

In the second and third embodiments, step (a) may further comprise incubating the suspension for a period of time of between about 1 and 60 minutes, at a temperature of between about 25° C. and 45° C., while shaking on a rotating platform set at between about 50 and 200 rpm, and step (b) may further comprise harvesting microbial cells from the suspension of (a), treating the harvested cells with a lysing agent at a temperature of between about 80° C. and 120° C. for about 10 to 120 minutes, pelleting the treated cells, and harvesting of the supernatant. In a further aspect of step (b), the supernatant is lyophilized to form a powder, the powder is washed with a first solvent, and the powder is extracted with a second solvent.

In aspects of these embodiments, the first solvent may be, but is not limited to, methanol, and the second solvent may be, but is not limited to, a mixture of chloroform, methanol and water. In one aspect, the second solvent may comprise a mixture of chloroform, methanol and water, in a ratio of 3:1.5:0.25 (v:v:v).

In aspects of these embodiments, the lysing agent may be a mixture of ammonia hydroxide and isobutyric acid in a ratio of about 1:5 to 5:1 (v/v). In one particular aspect, the mixture of ammonia hydroxide and isobutyric acid may be a mixture of 1M ammonia hydroxide and isobutyric acid in a ratio of about 3:5 (v/v).

In a fourth embodiment, the invention is drawn to a method of obtaining lipids from a microbe comprising:

(a) mixing microbial cells with a surfactant to form a suspension, wherein the suspension is incubated for a period of time of between about 1 and 60 minutes, at a temperature of between about 25° C. and 45° C., while shaking on a rotating platform set at between about 50 and 200 rpm, and

(b) extracting lipids from the suspension of (a) using an ammonium-isobutyric acid lysing agent, wherein the microbial cells from the suspension are harvested and treated with a mixture of ammonia hydroxide and isobutyric acid under a temperature of between about 80° C. and 120° C. for a period of time of about 10 to 120 minutes, followed by centrifugation of the treated cells, harvesting of supernatant, lyophilization of the supernatant to form a powder, washing the powder with a first solvent, and extracting the powder with a second solvent.

In this embodiment, the microbe may be a bacterium, a fungus, or a mixture of both. In one aspect, the microbe is a gram-negative bacterium. In one aspect, the microbe is a gram-positive bacterium.

In this embodiment, the mixture of ammonia hydroxide and isobutyric acid may be a mixture of 1M ammonia hydroxide and isobutyric acid in a ratio of about 1:5 to 5:1 (v/v). In one aspect, the mixture of ammonia hydroxide and isobutyric acid may be a mixture of 1M ammonia hydroxide and isobutyric acid in a ratio of about 3:5 (v/v).

In this embodiment, the first solvent may be, but is not limited to, methanol, and the second solvent may be, but is not limited to, a mixture of chloroform, methanol and water. In one aspect, the second solvent may comprise a mixture of chloroform, methanol and water, in a ratio of 3:1.5:0.25 (v:v:v).

In a fifth embodiment, the invention is drawn to a method of obtaining lipids from a microbe comprising:

(a) mixing microbial cells with a surfactant to form a suspension, wherein the suspension is incubated for a period of time of about 30 minutes, at a temperature of about 37° C., while shaking on a rotating platform set at about 125 rpm, and

(b) extracting lipids from the suspension of (a) using an ammonium-isobutyric acid lysing agent, wherein the microbial cells from the suspension are harvested and treated with a mixture of ammonia hydroxide and isobutyric acid (3:5, v/v) under a temperature of about 100° C. for a period of time of about 60 minutes, followed by centrifugation of the treated cells, harvesting of supernatant, lyophilization of the supernatant to form a powder, washing the powder with methanol, and extracting the powder with a mixture of chloroform, methanol and water.

In this embodiment, the microbe may be a bacterium, a fungus, or a mixture of both. In one aspect, the microbe is a gram-negative bacterium. In one aspect, the microbe is a gram-positive bacterium.

In this embodiment, the mixture of chloroform, methanol and water may be a mixture of chloroform, methanol and water in a ratio of 3:1.5:0.25 (v:v:v).

In a sixth embodiment, the invention is drawn to a method of obtaining lipids from a microbe comprising:

(a) mixing microbial cells with a surfactant to form a suspension, wherein the surfactant is Tween-80 (5%, v/v), the suspension is incubated for a period of time of about 30 minutes, at a temperature of about 37° C., while shaking on a rotating platform set at about 125 rpm, and

(b) extracting lipids from the suspension of (a) using an ammonium-isobutyric acid lysing agent, wherein the microbial cells from the suspension are harvested and treated with a mixture of ammonia hydroxide and isobutyric acid (3:5, v/v) under a temperature of about 100° C. for a period of time of about 60 minutes, followed by centrifugation of the treated cells, harvesting of the supernatant, lyophilization of the supernatant to form a powder, washing the powder with methanol, and extracting the powder with a mixture (3:1.5:0.25, v:v:v) of chloroform, methanol and water.

In this embodiment, the microbe may be a bacterium, a fungus, or a mixture of both. In one aspect, the microbe is a gram-negative bacterium. In one aspect, the microbe is a gram-positive bacterium.

As indicated above, the present invention includes methods for obtaining lipid molecules from microbial cells where the surfactant is combined with a lysing agent in a step of lipid extraction. Thus, and in a seventh embodiment, the invention is drawn to a method of obtaining lipids from a microbe comprising (a) mixing microbial cells with (i) a surfactant and (ii) a lysing agent to form a suspension, and (b) extracting lipids from the suspension.

In an eighth embodiment, the invention is drawn to a method of obtaining lipids from a microbe comprising (a) mixing microbial cells with (i) a surfactant and (ii) an ammonium-isobutyric acid lysing agent to form a suspension, and (b) extracting lipids from the suspension.

In both of these embodiments, the microbe may be a bacterium, a fungus, or a mixture of both. In one aspect, the microbe is a gram-negative bacterium. In one aspect, the microbe is a gram-positive bacterium.

In both of these embodiments, step (a) may further comprise mixing the suspension under conditions of a temperature of between about 80° C. and 120° C. for a period of time of about 10 to 120 minutes. In one aspect, the suspension is mixed under conditions of a temperature of about 100° C. for a period of time of about 60 minutes.

In both of these embodiments, step (b) may further comprise centrifugation of the suspension, harvesting of supernatant, lyophilization of the supernatant to form a powder, washing the powder with a first solvent, and extracting the powder with a second solvent.

In both of these embodiments, the lysing agent may be present in a concentration of between about 75 and 99.9% (v/v) of the suspension.

In a ninth embodiment, the invention is drawn to a method of obtaining lipids from a microbe comprising:

(a) mixing microbial cells with (i) a surfactant and (ii) an ammonium-isobutyric acid lysing agent to form a suspension, wherein the suspension is incubated under conditions of a temperature of between about 80° C. and 120° C. for a period of time of about 10 to 120 minutes, and

(b) extracting lipids from the suspension of (a) by centrifugation of the suspension, harvesting of supernatant, lyophilization of the supernatant to form a powder, washing the powder with a first solvent, and extracting the powder with a second solvent.

In this embodiment, the microbe may be a bacterium, a fungus, or a mixture of both. In one aspect, the microbe is a gram-negative bacterium. In one aspect, the microbe is a gram-positive bacterium.

In this embodiment, the lysing agent may be present in a concentration of between about 75 and 99.9% (v/v) of the suspension.

In a tenth embodiment, the invention is drawn to a method of obtaining lipids from a microbe comprising:

(a) mixing microbial cells with (i) a surfactant and (ii) a mixture of ammonia hydroxide and isobutyric acid (3:5, v/v) to form a suspension, wherein the suspension is incubated under conditions of a temperature of about 100° C. for a period of time of about 60 minutes, and

(b) extracting lipids from the suspension of (a) by centrifugation of the suspension, harvesting of supernatant, lyophilization of the supernatant to form a powder, washing the powder with methanol, and extracting the powder with a mixture of chloroform, methanol and water.

In this embodiment, the microbe may be a bacterium, a fungus, or a mixture of both. In one aspect, the microbe is a gram-negative bacterium. In one aspect, the microbe is a gram-positive bacterium.

In this embodiment, the mixture of chloroform, methanol and water may be a mixture of chloroform, methanol and water in a ratio of 3:1.5:0.25 (v:v:v).

In this embodiment, the lysing agent may be present in a concentration of between about 75 and 99.9% (v/v) of the suspension.

In an eleventh embodiment, the invention is drawn to a method of obtaining lipids from a microbe comprising:

(a) mixing microbial cells with (i) Tween-80 (5%, v/v) and (ii) a mixture of ammonia hydroxide and isobutyric acid (3:5, v/v) to form a suspension, wherein the suspension is incubated under conditions of a temperature of about 100° C. for a period of time of about 60 minutes, and

(b) extracting lipids from the suspension of (a) by centrifugation of the suspension, harvesting of supernatant, lyophilization of the supernatant to form a powder, washing the powder with methanol, and extracting the powder with a mixture (3:1.5:0.25, v:v:v) of chloroform, methanol and water.

In this embodiment, the microbe may be a bacterium, a fungus, or a mixture of both. In one aspect, the microbe is a gram-negative bacterium. In one aspect, the microbe is a gram-positive bacterium.

In this embodiment, the lysing agent may be present in a concentration of between about 75 and 99.9% (v/v) of the suspension.

In a related series of embodiments, the lysing agent use in the extraction can be replaced by microwave treatment of a suspension comprising the surfactant and microbial cells. Thus, and in a twelfth embodiment, the invention is drawn to a method of obtaining lipids from a microbe comprising

(a) mixing microbial cells with (i) a surfactant and (ii) a protease to form a suspension,

(b) lysing the microbial suspension of (a) with a microwave reaction device, and

(c) extracting lipids from the suspension of (b).

In this embodiment, the microbe may be a bacterium, a fungus, or a mixture of both. In one aspect, the microbe is a gram-negative bacterium. In one aspect, the microbe is a gram-positive bacterium.

In aspects of this embodiment, the suspension of (a) may further comprise (iii) a polysaccharidase.

In aspects of this embodiment, the suspension of (a) may be in an acetate buffer with a pH ranging from about 3 to 5.

In one aspect of this embodiment, the protease is proteinase K.

In this embodiment, the lysing of (b) comprises a microwave wattage setting of between about 25 to 250 W and a temperature of between about 25° C. to 110° C. for a time of between about 5 to 20 minutes.

In this embodiment, the extracting of (c) may comprise one or more of: (i) incubating the lysed microbial suspension of (b) at a temperature of between about 80° C. and 120° C. for a period of time of about 30 to 120 minutes, (ii) centrifugation to recover lipids, and (iii) solvent extraction to remove contaminants. In one aspect, the extracting of (c) comprising (i) and (ii), or (ii) and (iii), or (i) and (iii), or each of (i), (ii) and (iii). In certain aspects, the solvent is methanol.

In a thirteenth embodiment, the invention is drawn to a method of obtaining lipids from a microbe comprising

(a) mixing microbial cells with (i) a surfactant and (ii) a protease in an acetate buffer (pH 3-5) to form a suspension,

(b) lysing the microbial suspension of (a) with a microwave reaction device under conditions of between about 25 to 250 W, between about 25° C. to 110° C., for about 5 to 20 minutes, and

(c) extracting lipids from the suspension of (b) by incubating the lysed microbial suspension of (b) at 100° C. for about 30-120 minutes, centrifugation to recover lipids, and methanol extraction to remove contaminants.

In this embodiment, the microbe may be a bacterium, a fungus, or a mixture of both. In one aspect, the microbe is a gram-negative bacterium. In one aspect, the microbe is a gram-positive bacterium.

In aspects of this embodiment, the suspension of (a) may further comprise (iii) a polysaccharidase.

In one aspect of this embodiment, the protease is proteinase K.

In each of the relevant embodiments and aspects of the invention, the microbes may be a single strain or species of bacteria, or a mixture of different bacterial species and/or strains. In one aspect, the bacteria are in a suspension to which the surfactant is added. Alternatively, the microbes may be a single strain or species of fungi, or a mixture of different fungal species and/or strains. In one aspect, the fungi are in a suspension to which the surfactant is added. In addition, the microbes may be a mixture of (i) one or more bacterial species and/or strains and (ii) one or more fungal species and/or strains.

In each of the relevant embodiments and aspects of the invention, the lipid that is obtained may be one or more lipids selected from the group consisting of bacterial lipid A, bacterial lipoteichoic acid, a phospholipid, a glycerophospholipid, a sphingolipid, a sterol, and a precursor thereof. When the microbe is a bacterium, the lipid may include, but is not limited to, lipid A. In one aspect, the microbe is a bacterium and the lipid that is obtained is limited to lipid A.

In each of the relevant embodiments and aspects of the invention, the suspension of (a) may comprise between about 0.5 to 10% (v/v) of the surfactant. In certain aspects, the suspension of (a) may comprise about 5% (v/v) of the surfactant.

In each of the relevant embodiments and aspects of the invention, the surfactant may be, but is not limited to, an anionic, cationic, zwitterionic, or non-ionic surfactant. In one aspect, the surfactant is a non-ionic surfactant. Exemplary types of surfactants include Tritons, saponins and Tweens (polysorbates). Exemplary surfactants include Triton X-100, Saponin, Tergitol and Tween-80.

In each of the relevant embodiments and aspects of the invention, the lysing agent may be present in a concentration of between about 75 to 100% (v/v) of the suspension.

In each of the relevant embodiments and aspects of the invention, the ammonium-isobutyric acid lysing agent and the mixture of ammonia hydroxide and isobutyric acid may be a mixture of 1M ammonia hydroxide and isobutyric acid in a ratio of about 1:5 to 5:1 (v/v). In one aspect of the embodiment, the ratio is about 3:5 (v/v).

In each of the relevant embodiments and aspects of the invention, the methods can be used in conjunction with mass spectrometric characterization of the lipids obtained from the methods to identify the bacteria or fungi from which the lipids were obtained. Such methods of mass spectrometric characterization include those described in U.S. Application Publication No. 2012/0197535 and U.S. Pat. No. 8,415,619, both of which are incorporated herein by reference in their entirety.

The foregoing has outlined rather broadly the features and technical advantages of the present invention in order that the detailed description of the invention that follows may be better understood. Additional features and advantages of the invention will be described herein, which form the subject of the claims of the invention. It should be appreciated by those skilled in the art that any conception and specific embodiment disclosed herein may be readily utilized as a basis for modifying or designing other means for carrying out the same purposes of the present invention. It should also be realized by those skilled in the art that such equivalent means do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that any description, figure, example, etc. is provided for the purpose of illustration and description only and is by no means intended to define the limits the invention.

### BRIEF DESCRIPTION OF DRAWINGS

FIG. 1—mass spectra of lipids obtained from V. cholerae strain Argentina O-139 using the traditional small scale technique of El Hamidi et al. (J. Lipid Res. 46:1773-1778 (2005)).

FIGS. 2A-2B—mass spectra of lipids obtained from V. cholerae strain Argentina O-139 using pre-treatment of bacterial cells in 5% Tween-80 (FIG. 2A) or 10% Tween-80 (FIG. 2B).

FIGS. 3A-3B—mass spectra of lipids obtained from V. cholerae strain Argentina O-139 where bacterial cells were pre-treated with (FIG. 3B) or without (FIG. 3A) 5% Tween-80.

FIGS. 4A-4D—graphs showing signal-to-noise ratios for major lipid A species obtained from Francisella novicida strain U112, where FIGS. 4A and 4B show the ion species 1665 m/z, and FIGS. 4C and 4D show the ion species 1827 m/z. Left and right panels are from duplicate growth tubes.

FIGS. 5A-5B—graphs showing signal-to-noise ratios for major lipid A species obtained from E. coli strain DH5α, where FIGS. 5A and 5B show the ion species 1797 m/z. Left and right panels are from duplicate growth tubes.

FIGS. 6A-6D—graphs showing signal-to-noise ratios for major lipid A species obtained from S. Typhimuirium strain CS339, where FIGS. 6A and 6B show the ion species 1797 m/z, and FIGS. 6C and 6D show the ion species 2035 m/z. Left and right panels are from duplicate growth tubes.

FIGS. 7A-7B—graphs showing signal-to-noise ratios for major lipid A species obtained from V. cholerae strain N16861 (O-1 O antigen), where FIGS. 7A and 7B show the ion species 1757 m/z. Left and right panels are from duplicate growth tubes.

FIGS. 8A-8B—graphs showing signal-to-noise ratios for major lipid A species obtained from V. cholerae strain Argentina O-139, where FIGS. 8A and 8B show the ion species 1797 m/z. Left and right panels are from duplicate growth tubes.

FIGS. 9A-9B—graphs showing signal-to-noise ratios for major lipid A species obtained from A. baumanii strain AC1C4, where FIGS. 9A and 9B show the ion species 1910 m/z. Left and right panels are from duplicate growth tubes.

### DETAILED DESCRIPTION OF THE INVENTION

### I. Definitions

Unless otherwise noted, technical terms are used according to conventional usage.

As used herein, “a” or “an” may mean one or more. As used herein when used in conjunction with the word “comprising,” the words “a” or “an” may mean one or more than one. As used herein “another” may mean at least a second or more. Furthermore, unless otherwise required by context, singular terms include pluralities and plural terms include the singular.

As used herein, “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In some instances, the term “about” may include numerical values that are rounded to the nearest significant figure.

### II. The Present Invention

As disclosed herein, the inventors have surprisingly discovered that through the use of surfactants, lipids can be obtained from bacteria and fungi in a manner that is quicker and less toxic than means currently known for obtaining lipids from bacterial and fungal cells.

The methods of the present invention include alternative means for contacting microbial cells with a surfactant. In certain embodiments of the invention, methods of obtaining lipids from a microbe comprise (a) mixing microbial cells with a surfactant to form a suspension, and (b) extracting lipids from the suspension. Thus, in these embodiments the microbial cells are pre-treated with the surfactant prior to the extraction step.

The specific conditions under which the mixing of (a) takes place and the suspension is formed can vary widely depending, for example, on the identity of the surfactant, the identity of the microbe (when known) and other components that might be included in the suspension, such as when the microbe is used in the context of a biological sample. However, the suspension of (a) will generally be incubated for a period of time of between about 1 and 180 minutes, at a temperature of between about 20° C. and 75° C., while shaking, such as on a rotating platform set at between about 50 and 200 rpm. Exemplary conditions include incubating for about 30 minutes, at about 37° C., while shaking on a rotating platform set at about 125 rpm. Specific periods of time include, but are not limited to, 1, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175 and 180 minutes, or more. Specific ranges of time include, but are not limited to, 1 to 60 minutes, 10 to 50 minutes, and 15 to 45 minutes. Specific temperatures include, but are not limited to, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, or 75° C., or more. Specific ranges of temperature include, but are not limited to, 30 to 45° C., 33 to 42° C., and 35 to 40° C.

The specific conditions under which the extracting of (b) takes place will also vary widely depending, for example, on the identity of the surfactant, the identity of the microbe (when known) and other components that might be included in the suspension, such as when the microbe is used in the context of a biological sample. Indeed, there are a large number of means for extracting lipids known in the art. However, step (b) will typically comprise one or more of: (i) harvesting microbial cells from the suspension of (a), and (ii) treating the microbial cells from the suspension of (a) with the lysing agent under conditions of a heating for a period of time, followed by pelleting the treated cells, harvesting of the supernatant, lyophilization of the supernatant to form a powder, washing the powder with a first solvent, and extracting the powder with a second solvent.

Exemplary means make use of a lysing agent, such as an ammonium-isobutyric acid solution. When used as the lysing agent, the ammonium-isobutyric acid solution is a mixture of ammonia hydroxide and isobutyric acid. Such solutions and mixtures will typically contain 1M ammonia hydroxide, although 0.5 M to 1.5 M ammonia hydroxide may also be used. Such solutions and mixtures will typically consist of ammonia hydroxide and isobutyric acid in a ratio of about 1:5 to 5:1 (v/v). Specific ratios include 1:5, 2:5, 3:5, 4:5, 5:5, 5:4, 5:3, 5:2, and 5:1 (v/v).

Lysing agents that may be used in the extracting step in place of an ammonium-isobutyric acid solution include, but are not limited to, phenol, chloroform, ether, and EDTA, for example.

The concentration of the lysing agent used in the methods of the invention will vary depending, for example, on the identity of the agent and the concentration of the microbial cells in a given suspension. However, typical concentration may include between about 75 to 100% (v/v) in the suspension.

When an ammonium-isobutyric acid lysing agent is used in the extracting of (b), the cells of the suspension are treated with the ammonium-isobutyric acid solution under conditions of a temperature of between about 80° C. and 180° C. for a period of time of about 10 to 120 minutes. Exemplary conditions include treating for about 60 minutes, at about 100° C. Specific temperatures include, but are not limited to, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119 or 120° C., or more. Specific ranges of temperature include, but are not limited to, 75 to 125° C., 85 to 115° C., and 90 to 100° C. Specific periods of time include, but are not limited to, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175 and 180 minutes, or more. Specific ranges of time include, but are not limited to, 30 to 90 minutes, 40 to 80 minutes, and 50 to 70 minutes.

The typical concentration of the ammonium-isobutyric acid lysing agent in the suspension is between about 75 to 100% (v/v).

After treatment of the microbial cells with the lysing agent, the cells are pelleted via centrifugation and the supernatant is harvested. The supernatant is typically further processed through lyophilization to form a powder, the powder is washed with a first solvent, and the powder is extracted with a second solvent. Suitable solvents for the first wash include, but are not limited to, methanol, ethanol, butanol, and propanol. Suitable solvents for the second wash include, but are not limited to, a mixture of chloroform, methanol and water, as well as ethanol, butanol, or propanol. In one aspect, the second solvent comprises a mixture of chloroform, methanol and water, in a ratio of 3:1.5:0.25 (v:v:v).

In a specific embodiment, the invention is drawn to a method of obtaining lipids from a microbe comprising:

(a) mixing microbial cells with a surfactant to form a suspension, wherein the suspension is incubated for a period of time of between about 1 and 60 minutes, at a temperature of between about 25° C. and 45° C., while shaking on a rotating platform set at between about 50 and 200 rpm, and

(b) extracting lipids from the suspension of (a) using an ammonium-isobutyric acid lysing agent, wherein the microbial cells from the suspension are harvested and treated with a mixture of 1M ammonia hydroxide and isobutyric acid (1:5 to 5:1 (v/v)) and under a temperature of between about 80° C. and 120° C. for a period of time of about 10 to 120 minutes, followed by centrifugation of the treated cells, harvesting of supernatant, lyophilization of the supernatant to form a powder, washing the powder with methanol, and extracting the powder with a mixture of chloroform, methanol and water.

In another specific embodiment, the invention is drawn to a method of obtaining lipids from a microbe comprising:

(a) mixing microbial cells with a surfactant to form a suspension, wherein the surfactant is Tween-80 (5%, v/v), the suspension is incubated for a period of time of about 30 minutes, at a temperature of about 37° C., while shaking on a rotating platform set at about 125 rpm, and

(b) extracting lipids from the suspension of (a) using an ammonium-isobutyric acid lysing agent, wherein the microbial cells from the suspension are harvested and treated with a mixture of ammonia hydroxide and isobutyric acid (3:5, v/v) under a temperature of about 100° C. for a period of time of about 60 minutes, followed by centrifugation of the treated cells, harvesting of the supernatant, lyophilization of the supernatant to form a powder, washing the powder with methanol, and extracting the powder with a mixture of chloroform, methanol and water (3:1.5:0.25, v:v:v).

The methods of the present invention also include methods for obtaining lipid molecules from microbial cells where the surfactant is combined with a lysing agent in a step of lipid extraction. In certain embodiments, the invention is thus drawn to a method of obtaining lipids from microbes comprising (a) mixing microbial cells with (i) a surfactant and (ii) a lysing agent to form a suspension, and (b) extracting lipids from the suspension.

The specific conditions under which the mixing of (a) takes place and the suspension is formed can vary widely depending, for example, on the identity of the surfactant, the identity of the lysing agent, the identity of the microbe (when known) and other components that might be included in the suspension, such as when the microbe is used in the context of a biological sample. However, the suspension of (a) will generally be incubated for a period of time of between about 1 and 180 minutes, at a temperature of between about 80° C. and 120° C. Exemplary conditions include incubating for about 60 minutes, at about 100° C. Specific periods of time include, but are not limited to, 1, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175 and 180 minutes, or more. Specific ranges of time include, but are not limited to, 30 to 90 minutes, 40 to 80 minutes, and 50 to 70 minutes. Specific temperatures include, but are not limited to, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119 or 120° C., or more. Specific ranges of temperature include, but are not limited to, 75 to 125° C., 85 to 115° C., and 90 to 110° C.

Exemplary lysing agents include, but are not limited to, an ammonium-isobutyric acid solution, phenol, chloroform, ether, and EDTA, for example. When used as the lysing agent, the ammonium-isobutyric acid solution is a mixture of ammonia hydroxide and isobutyric acid. Such solutions and mixtures will typically contain 1M ammonia hydroxide, although 0.5 M to 1.5 M ammonia hydroxide may also be used. Such solutions and mixtures will typically consist of ammonia hydroxide and isobutyric acid in a ratio of about 1:5 to 5:1 (v/v). Specific ratios include 1:5, 2:5, 3:5, 4:5, 5:5, 5:4, 5:3, 5:2, and 5:1 (v/v).

The concentration of the lysing agent used will vary depending, for example, on the identity of the agent and the concentration of the microbial cells in a given suspension. However, typical concentration may include between about 75 to 99.9% (v/v) in the suspension.

The lipids may be extracted from the suspension in (b) any of the means known in the art. However, in a particular aspect and after formation of the suspension in (a), the cells of the suspension are pelleted via centrifugation and the supernatant is harvested. The supernatant is typically further processed through lyophilization to form a powder, the powder is washed with a first solvent, and the powder is extracted with a second solvent. Suitable solvents for the first wash include, but are not limited to, methanol, ethanol, butanol, and propanol. Suitable solvents for the second wash include, but are not limited to, a mixture of chloroform, methanol and water, as well as ethanol, butanol, or propanol. In one aspect, the second solvent comprises a mixture of chloroform, methanol and water, in a ratio of 3:1.5:0.25 (v:v:v).

In a specific embodiment, the invention is drawn to a method of obtaining lipids from a microbe comprising:

(a) mixing microbial cells with (i) a surfactant and (ii) an ammonium-isobutyric acid lysing agent to form a suspension, wherein the suspension is incubated under conditions of a temperature of between about 80° C. and 120° C. for a period of time of about 10 to 120 minutes, and

(b) extracting lipids from the suspension of (a) by centrifugation of the suspension, harvesting of supernatant, lyophilization of the supernatant to form a powder, washing the powder with a first solvent, and extracting the powder with a second solvent.

In this embodiment, the lysing agent may be present in a concentration of between about 75 and 99.9% (v/v) of the suspension.

In another specific embodiment, the invention is drawn to a method of obtaining lipids from a microbe comprising:

(a) mixing microbial cells with (i) a surfactant and (ii) a mixture of ammonia hydroxide and isobutyric acid (3:5, v/v) as a lysing agent to form a suspension, wherein the suspension is incubated under conditions of a temperature of about 100° C. for a period of time of about 60 minutes, and

(b) extracting lipids from the suspension of (a) by centrifugation of the suspension, harvesting of supernatant, lyophilization of the supernatant to form a powder, washing the powder with methanol, and extracting the powder with a mixture (3:1.5:0.25 (v:v:v)) of chloroform, methanol and water.

In this embodiment, the lysing agent may be present in a concentration of between about 75 and 99.9% (v/v) of the suspension.

In a further specific embodiment, the invention is drawn to a method of obtaining lipids from a microbe comprising:

(a) mixing microbial cells with (i) Tween-80 (5%, v/v) and (ii) a mixture of ammonia hydroxide and isobutyric acid (3:5, v/v) as a lysing agent to form a suspension, wherein the suspension is incubated under conditions of a temperature of about 100° C. for a period of time of about 60 minutes, and

(b) extracting lipids from the suspension of (a) by centrifugation of the suspension, harvesting of supernatant, lyophilization of the supernatant to form a powder, washing the powder with methanol, and extracting the powder with a mixture (3:1.5:0.25, v:v:v) of chloroform, methanol and water.

In this embodiment, the lysing agent may be present in a concentration of between about 75 and 99.9% (v/v) of the suspension.

The methods of the present invention also include methods for obtaining lipid molecules from microbial where the lysing agent is replace by a microwave reaction device. In certain embodiments, the invention is thus drawn to a method of obtaining lipids from a microbe comprising

(a) mixing microbial cells with (i) a surfactant and (ii) a protease to form a suspension,

(b) lysing the microbial suspension of (a) with a microwave reaction device, and

(c) extracting lipids from the suspension of (b).

The specific conditions under which the mixing of (a) takes place and the suspension is formed can vary widely depending, for example, on the identity of the surfactant, the identity of the protease, the identity of the microbe (when known) and other components that might be included in the suspension, such as when the microbe is used in the context of a biological sample. However, the suspension will typically be supplemented with an acetate buffer having a pH ranging from about 3 to 5. Suitable proteases include, but are not limited to, proteinase K, endopeptidase K, Tritirachium alkaline proteinase, and Tritirachium album serine proteinase, for example.

Additional enzymes can be included in the suspension, for example to aid in the breakdown of bacterial glycocalyx or outer polysaccharides. Such enzymes include polysaccharidases and glycosidases. Specific examples include xylanase, carboxymethyl cellulase (CMCase), lichenase, amylase, beta-xylosidase, beta-glucosidase and alpha-L-arabinofuranosidase.

The specific conditions under which the lysing of (b) takes place can vary widely depending, for example, on the identity of the surfactant, the identity of the protease, the identity of the microbe (when known) and other components that might be included in the suspension, such as when the microbe is used in the context of a biological sample. However, the lysing is generally conducted under conditions of microwave wattage of between about 25 to 250 W and a temperature of between about 25° C. to 110° C. for a time of between about 1 to 20 minutes.

Specific wattages include, but are not limited to, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245 or 250, or more. Specific ranges of wattage include, but are not limited to, 30 to 90 W, 40 to 80 W, and 50 to 70 W. Specific temperatures include, but are not limited to, 25, 30, 35, 40, 45, 50, 55, 60, 65, 70, 75, 80, 85, 90, 95, 100, 105 or 110° C., or more. Specific ranges of temperature include, but are not limited to, 25 to 75° C., 35 to 65° C., and 45 to 55° C. Specific periods of time include, but are not limited to, 1, 2, 3, 4, 5, 6, 7, 8, 9, 10, 11, 12, 13, 14, 15, 16, 17, 18, 19 and 20 minutes, or more. Specific ranges of time include, but are not limited to, 1 to 10 minutes, 2 to 8 minutes, and 3 to 7 minutes.

Suitable microwave reaction devices will be known in the art but include, for example, the microwave reaction device produced by Discovery System, CEM Corp. (Mathews, N.C.), the SynthWAVE single reaction chamber (SRC), and the Anton Paar Multiwave PRO microwave reaction system.

The specific conditions under which the extracting of (c) takes place can vary widely depending, for example, on the conditions of the microwave reaction. However, the conditions generally include incubating the lysed microbial suspension of (b) at a temperature of between about 80° C. and 120° C. for a period of time of about 30 to 120 minutes, centrifugation to recover lipids, and solvent extraction to remove contaminants. Specific temperatures include, but are not limited to, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119 or 120° C., or more. Specific ranges of temperature include, but are not limited to, 75 to 125° C., 85 to 115° C., and 90 to 110° C. Specific periods of time include, but are not limited to, 30, 35, 40, 45, 50, 55, 60, 65, 70, 75, 80, 85, 90, 95, 100, 105, 110, 115 and 120 minutes, or more. Specific ranges of time include, but are not limited to, 30 to 90 minutes, 40 to 80 minutes, and 50 to 70 minutes. The solvent for extraction may be, but is not limited to, methanol, ethanol, butanol, and propanol.

In a specific embodiment, the invention is drawn to a method of obtaining lipids from a microbe comprising:

(a) mixing microbial cells with (i) a surfactant and (ii) a protease in an acetate buffer (pH 3-5) to form a suspension,

(b) lysing the microbial suspension of (a) with a microwave reaction device under conditions of between about 25 to 250 W, between about 25° C. to 110° C., for about 5 to 20 minutes, and

(c) extracting lipids from the suspension of (b) by incubating the lysed microbial suspension of (b) at 100° C. for about 30-120 minutes, centrifugation to recover lipids, and methanol extraction to remove contaminants. Step (c) may further comprise recovery of lipid as a methanol-insoluble product, solubilization of the lipids in a second solvent, such as chloroform methanol and water, in particular, (3:1.5:0.25 (v/v/v) chloroform:methanol:water.

In one aspects of this embodiment, a polysaccharidase is included in the suspension of (a).

The microbes and suspensions comprising the microbial cells from which lipids may be obtained using in the methods of the present invention are not limited in any manner. As to the identity of the microbes, the present invention includes gram-positive bacteria, gram-negative bacteria and fungi. Because fungi and Gram-negative bacterial membranes contain lipids as an essential component, the present invention is particularly relevant to obtaining lipids from fungi and Gram-negative bacteria. The methods of the present invention may be practiced using suspension of a single strain or species of bacteria, a single strain or species of fungi, a mixture of different bacterial species and/or strains, a mixture of different fungal species and/or strains, or a mixture of different bacterial and fungal species and/or strains. The bacteria and fungi may be dead or alive.

As to the source of the microbes, while it is helpful to use microbes that have been isolated from a laboratory sample or a culture (e.g., as a colony from a culture plate or liquid culture), and thus exists as a “pure” culture or suspension, the methods of the present invention may also be practiced using a sample or culture that has not first been processed to render a pure culture or suspension. Thus, the sample may be any suitable sample of interest that is believed to contain a microbe to be identified. Non-limiting examples of test samples include, but are not limited to water samples (including but not limited to water samples from ponds, streams, lakes, oceans, seas, wastewater, reservoirs, drinking water, water distribution pipeline, etc.), body fluid samples (including but not limited to wound secretions/scrapings, blood, urine, sweat, saliva, vaginal secretions, sputum), beverage samples, and liquid medicine samples. Because microbes can easily be collected from non-liquid sources, the sample may also be one or more of food samples, environmental samples (for example, dirt), medical facilities (for example, from, medical centers such as linens, medical devices, etc.), solid waste samples, diagnostic samples, air, air filters, air duct and breath samples, or from pharmaceutical facilities (for example, from, manufacturing or processing lines), food production facilities, or livestock facilities.

The sample can be used as obtained, or can be processed in any way suitable for use with the methods of the invention. For example, the microbes can be used directly in the methods after collection, or they can be subject to amplification such as by streaking onto solid culture medium, followed by growth for an appropriate period of time or used to initiate a larger-scale culture (for example, an overnight liquid culture). The microbes may also be subject to purification when the sample includes components that may interfere with one or more of the steps of the methods disclosed herein. It is within the level of skill in the art, based on the teachings herein, to determine an appropriate strategy for processing the sample for a specific use.

In the various non-limiting embodiments and aspects, the methods can be used to obtain lipids from one or more of the following bacteria (or sub-species thereof): Escherichia coli, Staphylococcus aureus, Staphylococcus epidermidis, Streptococcus pneumoniae, S. mitis, Streptococcus pyogenes, Stenotrophomonas maltophila, Mycobacterium tuberculosis, Neisseria gonorrhoeae, Neisseria meningitidis, Bordetella pertussis, B. bronchioseptica, Enterococcus faecalis, Salmonella typhimurium, Salmonella choleraesuis, Klebsiella pneumoniae, Pseudomonas aeruginosa, Acinetobacter baumannii, A. calcoaceticus, Bacteroides nordii, B. salyersiae, Enterobacter subspecies including E. asburiae, E. cloacae, E. hormaechei, E. kobei, E. ludwigii, and E. nimipressuralis, extended spectrum β-lactamase organisms, as well as bacterium in the genus Acinetobacter, Actinomyces, Bacillus, Bacteroides, Bordetella, Borrelia, Brucella, Clostridium, Corynebacterium, Campylobacter, Deinococcus, Escherichia, Enterobacter, Enterococcus, Erwinia, Eubacterium, Flavobacterium, Francisella, Gluconobacter, Helicobacter, Intrasporangium, Janthinobacterium, Klebsiella, Kingella, Legionella, Leptospira, Mycobacterium, Moraxella, Neisseria, Oscillospira, Proteus, Pseudomonas, Providencia, Rickettsia, Salmonella, Staphylococcus, Shigella, Spirillum, Streptococcus, Stenotrophomonas Treponema, Ureaplasma, Vibrio, Wolinella, Wolbachia, Xanthomonas, Yersinia, and Zoogloea.

The amount of bacteria in a suspension of the present invention may vary based on the identity of the bacteria and the other components in the suspension. However, the suspensions of the invention will typically contain between about 10² CFU/mL and 10¹⁰ CFU/mL.

In the various non-limiting embodiments and aspects, the methods can be used to obtain lipids from one or more of the following fungi (or sub-species thereof): Human and Livestock Fungal Pathogens: Candida, Aspergillus, Rhyzopus, Cryptococcus, Histoplasma, Pneumocystis, Stachybotrys, Sporothrix, Trichophyton, Microsporum, Blastomyces, Mucoromycotina, Coccidioides, Exserohilum, Cladosporium. Livestock Fungal Pathogens: Coccoides, Encephalitozoon, Encephalitozoon, Fusarium, Lichtheimia, Mortierella, Malassezia, Prototheca, Pythium, Rhodotorula. Crop Fungal Pathogens: Fusarium, Thielaviopsis, Verticillium, Magnaporthe, Sclerotinia, Ustilago, Rhizoctonia, Puccinia, Armillaria, Botrytis, Blumeria, Mycosphaerella, Colletotrichum, Melampsora. Fish Fungal Pathogens: Saprolegniasis, Ichthyosporidium, Exophiala, Branchiomycosis. Others: Penicillium. Representative fungal species include Histoplasma capsulatum, Blastomyces dermatitidis, Coccidioides immitis, Paracoccidioides brasiliensis, Aspergillus fumigatus, Candida albicans, Cryptococcus neoformans, Magnaporthe grisea, Sclerotinia sclerotiorum, Phakospora pachyrhizi and Botrytis cinerea.

The number of fungal cells in a suspension of the present invention may vary based on the identity of the fungus and the other components in the suspension. However, the suspensions of the invention will typically contain between about 10² and 10⁶ fungal cells.

The methods of the present invention may be used to obtain a wide variety of lipids from an even wider variety of bacterial species and strains. Exemplary bacterial lipids that can be obtained using the methods of the invention include lipid A, lipoteichoic acid (LTA), glycerophospholipids, sterols, phospholipids, and sphingolipids. The skilled artisan will appreciate that depending in the particular lipid to be obtained and the identity of the bacteria producing it, the methods of the present invention will vary within the parameters defined herein. For example, a higher concentration of surfactant may be required when isolating lipid A from one species of bacteria in comparison to another.

The methods of the present invention may also be used to obtain a wide variety of lipids from an even wider variety of fungal species and strains. As used herein, and in the context of fungi, “lipid” means lipids from fungi, such as cell wall lipids and cell membrane lipids. These lipids include, but are not limit to, glycerophospholipids, sphingolipids, and sterols, and precursors thereof. Thus, reference herein to fungal glycerophospholipids includes, but is not limited to, a fungal membrane glycerophospholipid; reference to fungal sphingolipids includes, but is not limited to, a fungal membrane sphingolipid; and reference to fungal sterols includes, but is not limited to, a fungal membrane sterol. The skilled artisan will appreciate that depending in the particular lipid to be obtained and the identity of the fungus producing it, the methods of the present invention will vary within the parameters defined herein. For example, a higher concentration of surfactant may be required when isolating a glycerophospholipid from one species of fungus in comparison to another

One of the technical features that unites each of the embodiments and aspects of the invention is the use of a surfactant in the methods. As used herein, a surfactant is a substance, such as a detergent that, when added to a microbial suspension, increases the ability of the lysing solution to extract membrane or wall lipids. Surfactants must be partly hydrophobic (water-soluble) and partly lipophilic (soluble in lipids or oils). They concentrate at the interfaces between membrane lipids and the lysing solution, to act as an emulsifying or extraction agent. The identity of the surfactant is not limited and includes anionic, cationic, zwitterionic, and non-ionic surfactants. Anionic surfactants include, but are not limited to, ammonium lauryl sulfate, sodium lauryl sulfate (SDS, sodium dodecyl sulfate) and sodium laureth sulfate. Cationic surfactants include, but are not limited to, cetyl trimethylammonium bromide (CTAB), cetyl trimethylammonium chloride (CTAC), cetylpyridinium chloride (CPC), benzalkonium chloride (BAC), benzethonium chloride (BZT), 5-bromo-5-nitro-1,3-dioxane, dimethyldioctadecylammonium chloride, cetrimonium bromide and dioctadecyldimethylammonium bromide (DODAB). Zwitterionic surfactants include, but are not limited to, 3-[(3-cholamidopropyl)dimethylammonio]-1-propanesulfonate) (CHAPS), cocamidopropyl hydroxysultaine, cocamidopropyl betaine, phosphatidylserine, phosphatidylethanolamine, phosphatidylcholine, and sphingomyelins. Non-ionic surfactants include, but are not limited to, polyoxyethylene glycol alkyl ethers (e.g., octaethylene glycol monododecyl ether and pentaethylene glycol monododecyl ether), polyoxypropylene glycol alkyl ethers, glucoside alkyl ethers (e.g., decyl glucoside, lauryl glucoside, octyl glucoside), polyoxyethylene glycol octylphenol ethers (e.g., Triton X-100), polyoxyethylene glycol alkylphenol ethers (e.g., nonoxynol-9), glycerol alkyl esters (e.g., glyceryl laurate), polyoxyethylene glycol sorbitan alkyl esters (e.g., polysorbate (Tween) 20, polysorbate (Tween) 40, polysorbate (Tween) 60, polysorbate (Tween) 80), sorbitan alkyl esters (e.g., Spans), cocamide MEA, cocamide DEA, dodecyldimethylamine oxide, block copolymers of polyethylene glycol and polypropylene glycol (e.g., poloxamers) and polyethoxylated tallow amine (POEA).

In one aspect, the surfactant is a non-ionic surfactant.

Exemplary types of surfactants include Tritons, saponins and Tweens (polysorbates).

Exemplary surfactants include Triton X-100, Saponin, Tergitol and Tween-80.

The amount of surfactant used in the methods of the invention can vary, depending on such factors as whether it is used in a separate pre-treatment step or used in conjunction with a lysing agent or protease, the identity of the lipids to be obtained, and the identity of the microbe, if known. However, the amount of surfactant will typically range from about 0.5 to 10% (v/v) in the suspension comprising the microbial cells and the surfactant. In particular aspects, the suspension may comprise about 0.5, 1, 1.5, 2, 2.5, 3, 3.5, 4, 4.5, 5, 5.5, 6, 6.5, 7, 7.5, 8, 8.5, 9, 9.5 or 10% (v/v), or more, of the surfactant. The amount may also range from about 0.5 to 5% (v/v), about 1.5 to 6% (v/v), about 2.5 to 17% (v/v), about 3.5 to 8% (v/v), about 4.5 to 9% (v/v), about 1 to 3% (v/v), about 3 to 6% (v/v), about 6 to 9% (v/v), about 0.5 to 2% (v/v), about 2.5 to 4% (v/v), about 4 to 6% (v/v), or about 8.5 to 10% (v/v).

The methods of the present invention include explicit means for extracting lipids from microbial cells, such as through the use of lysing agents or a microwave reaction device to lyse microbial cells. The skilled artisan will recognize that lipids can be extracted from microbial cells using other methods, with the only limitation on the particular method used being the inclusion of a pre-treatments step using a surfactant, or inclusion of a surfactant in the extraction method itself.

### III. Examples

### Example 1—Pre-Treatment with Surfactants

In this experiment, an assay developed for rapidly obtaining lipids from bacterial cells is provided. This extraction method, from minimal starting material and using strains of Vibrio cholerae, identified a novel lipid A species. This novel lipid A, which contains non-hydroxylated fatty acid substitutions correlated with an increased sensitivity to the cationic peptide polymyxin E (colistin).

The bacterial strains used in this study are summarized in Table 1. All bacteria were grown in Luria Broth (LB) at 37° C. The bacteria were obtained from American Type Culture Collection (Manassas, Va.) as well as various academic collaborators and clinical laboratories.

TABLE 1

| | | Colistin MIC | |
|---|---|---|---|
| Strain | O antigen | μg/ml | MS |
| NRU-20461 | O-139 | 8, 8, 4 | 1740 |
| NRU-20455 | O-139 | 8 | 1740 |
| O-139 Argentina | O-139 | >250 | 1756 |
| N16861 | O-1 | >250 | 1756 |
| 1837 | O-139 | >250 | 1756 |
| FMU-089933 | O-139 | 31.5 | 1756 |
| N16117 | O-1 | >250 | 1756 |
| NG368/36 | O-139 | >250 | 1756 |
| NG288/36 | O-139 | >250 | 1756 |
| 114/98931 | O-1 | 125 | 1756 |
| 50-1 | O-1 | 4, 4, 8 | 1740 |
| 51-2 | O-1 | 4 | 1740 |
| 52-4 | O-1 | 4 | 1740 |
| 79-35 | O-1 | >250 | 1756 |
| M-702-3 | O-1 | >250 | 1756 |
| 32-14 | | >250 | 1756 |
| 33-36 | O-1 | >250 | 1756 |
| 461/99053 | O-1 | >250 | 1756 |
| 57-11 | O-139 | 4 | 1740 |
| 58-12 | O-1 | 125 | 1756 |
| 781 | O-1 | >250 | 1756 |
| 35-44 | O-1 | >250 | 1756 |

Single V. cholerae colonies were selected from plates and expanded in 5 ml of LB overnight at 37° C. The next morning surfactant (Triton X-100 (Sigma), Saponin (Sigma) or Tween-80 (Sigma)) was added to each colony at increasing concentrations (0.0%, 0.5%, 1.0%, 5.0%, 10.0%). Cultures were allowed to shake with detergent for 30 minutes at 37° C. 1 ml of culture was then harvested by centrifugation at 5000×g for 5 minutes. Cell pellets were then suspended in isobutyric acid and 1 M ammonia hydroxide (5:3 v:v). This mixture was then incubated for 1 h at 100° C. followed by centrifugation at 2000×g for 15 minutes. The supernatant was then harvested and lyophilized overnight. The following day the dried sample is washed with methanol and extracted in 100 μl of a chloroform, methanol and water mixture (3:1.5:0.25, v:v:v).

For analysis of the extracted lipids, one microliter of the various extractions was spotted on a MALDI plate followed by 1 μl of norharmane as a matrix and air dried. Samples were analyzed on a Bruker AutoFlex Speed (Bruker Daltronics, Billerica, Mass.), calibrated using Agilent Tuning Mix (Agilent Technologies, Foster City, Calif.).

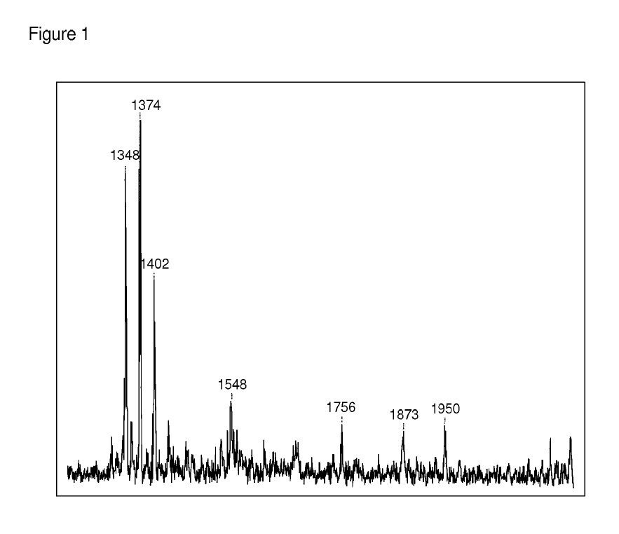

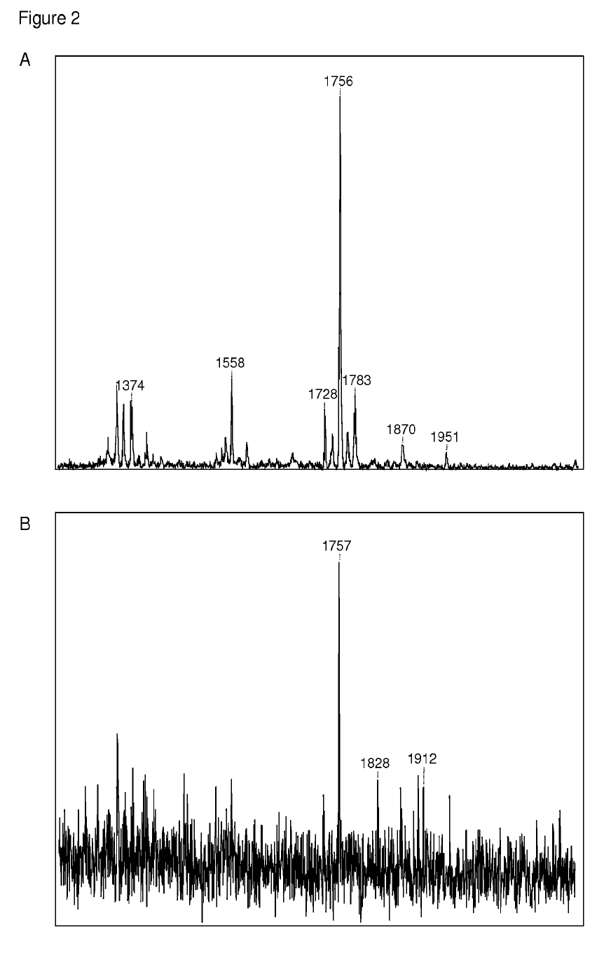

To date the only successful methods of extracting lipid A from V. cholera have been large scale techniques requiring large starting culture volumes and column fractionation. In this study, currently utilized small scale extraction techniques were adapted for the rapid isolation of lipid A from a relatively small sample volume. Traditional small scale isolation of the isolate Argentina O-139, as done by El Hamidi et al. (J. Lipid Res. 46:1773-1778 (2005)), failed to give a complete lipid A peak and instead gave a major peak of 1374 m/z, likely another cellular lipid (FIG. 1). Pretreatment with 5% Tween-80 improved the accessibility of the extraction solution to the bacterial membrane and yielded a major lipid species at 1756 m/z (FIG. 2A) similar to that seen in large scale extractions from Hankins et al. (Proc. Natl. Acad. Sci. USA 109(22):8722-8727 (2012)). Lower concentrations of Tween-20 (0.5, 1%) (data not shown) yielded similar spectra but with lower signal to noise ratios (data not shown). Higher concentrations (10%; FIG. 2B) caused a significant loss of signal. Other detergents (Triton X-100 and Saponin) gave similar results though both spectra also contained many new peaks, most likely soap residue or other bacterial lipids (data not shown).

O-139 strains of V. cholerae produce a capsule whereas O-1 strains do not. To determine if this adapted small-scale isolation technique was amenable to all V. cholerae strains, a variety of strain types from different geographical regions were examined (Table 1). All strains tested yielded usable spectra. Interestingly, a subset of strains yielded a phenotypically different lipid A species with a major peak of 1740 m/z (Table 1). Loss of 16 m/z units in a lipid A spectra is generally consistent with loss of a hydroxyl group. The strains making a smaller lipid A did not cluster within any single biotype, O-antigen, or geographical region.

To confirm that the change in lipid A mass seen in the MS analysis was due to a change in fatty acids, select strains were processed for analysis by gas chromatograph. All strains incorporated fatty acids of 3-OH C12, 3-OH C14, and C14 (data not shown). In support of the hypothesis, all strains that synthesized a lipid A of 1740 m/z showed a fatty acid peak of C12; this peak was not found in any of the strains producing a 1756 m/z lipid A.

### Example 2A—Microwave Extraction

A culture of Vibrio cholerae strain Argentina O-139 (Dr. James Kaper, University of Maryland, Baltimore) was pelleted through centrifugation at 5,000×g for 5 minutes. The pelleted cells were resuspended in acetate buffer at an acidic pH (3-5) containing proteinase K (60 ug/ml). A first portion of the bacterial slurry was supplemented with 5% Tween-80 and incubated for 30 minutes at 37° C. while gently shaken on a rotating platform. A second portion of the slurry was also gently shaken for 30 minutes at 37° C., but in the absence of any added surfactant.

The slurries were then lysed in a microwave reaction device (Discovery System, CEM Corp., Mathews, N.C.) for 5 minutes, at a microwave wattage of 50 W and a temperature of 58° C. The lysates were subsequently incubated at 100° C. for 60 minutes, during which the core sugar glycosidic linkage to lipid A was hydrolyzed. The resulting product was insoluble lipid A in an aqueous solution. Lipid A was collected by centrifugation and contaminants were washed away by successive rounds of methanol extraction. Lipid A was recovered as a methanol-insoluble product. Lipid A product was then solubilized in a mixture (3:1.5:0.25 (v:v:v)) of chloroform, methanol and water.

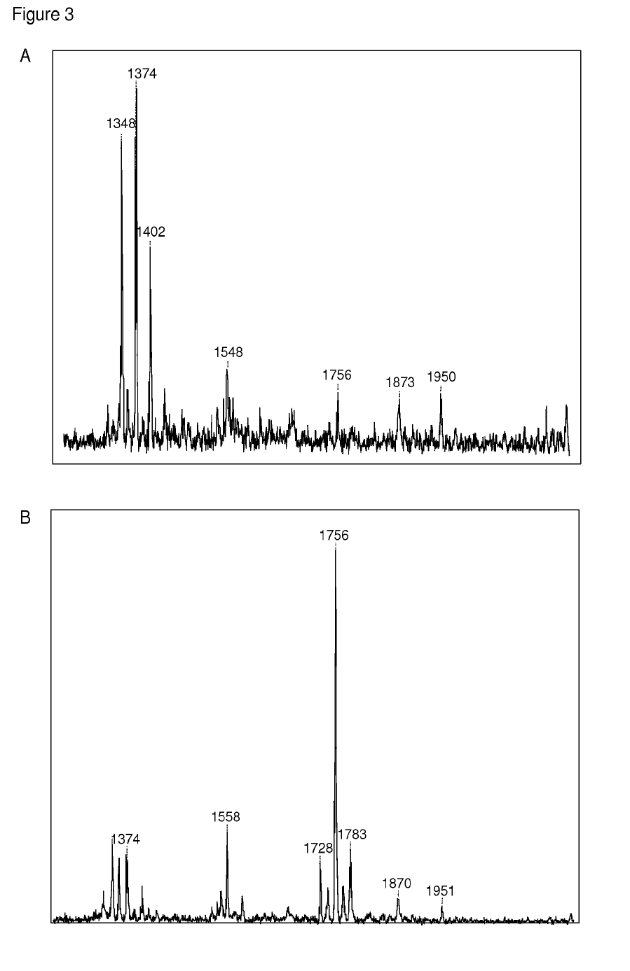

Mass spectra of the lipid A extracted from the two slurries (with or without 5% Tween-80) were determined using Bruker Autoflex Speed MALDI-TOF MS in the negative ion mode and are shown in FIGS. 3A and 3B. As can be seen, the complete lipid A structure (1756 m/z) is difficult to differentiate from the background and other peaks in the lipid A obtained from the slurry that did not include surfactant treatment (FIG. 3A), while the lipid A peak is much more apparent in the slurry treated with the surfactant (FIG. 3B).

### Example 2B—Microwave Extraction

A culture of Francisella novicida strain U112 (ATCC, Manassas, Va.) was pelleted through centrifugation at 5,000×g for 5 minutes. The pelleted cells were resuspended in acetate buffer at an acidic pH (3-5) containing proteinase K (60 ug/ml). Portions of the bacterial slurry were variously supplemented with Tween-80 (0.5%, 5%, 10%) or Triton X-100 (0.5%, 5%, 10%) and incubated for 30 minutes at 37° C. while gently shaken on a rotating platform. A further portion of the slurry was also gently shaken for 30 minutes at 37° C., but in the absence of any added surfactant.

The slurries were then lysed in a microwave reaction device (Discovery System, CEM Corp., Mathews, N.C.) for 5 minutes, at a microwave wattage of 50 W and a temperature of 58° C. The lysates were subsequently incubated at 100° C. for 60 minutes, during which the core sugar glycosidic linkage to lipid A was hydrolyzed. The resulting product was insoluble lipid A in an aqueous solution. Lipid A was collected by centrifugation and methanol (pure?) soluble contaminants were washed away by successive rounds of methanol resuspension and lipid A recovery. Lipid A product was then solubilized in organic solvent (which one?).

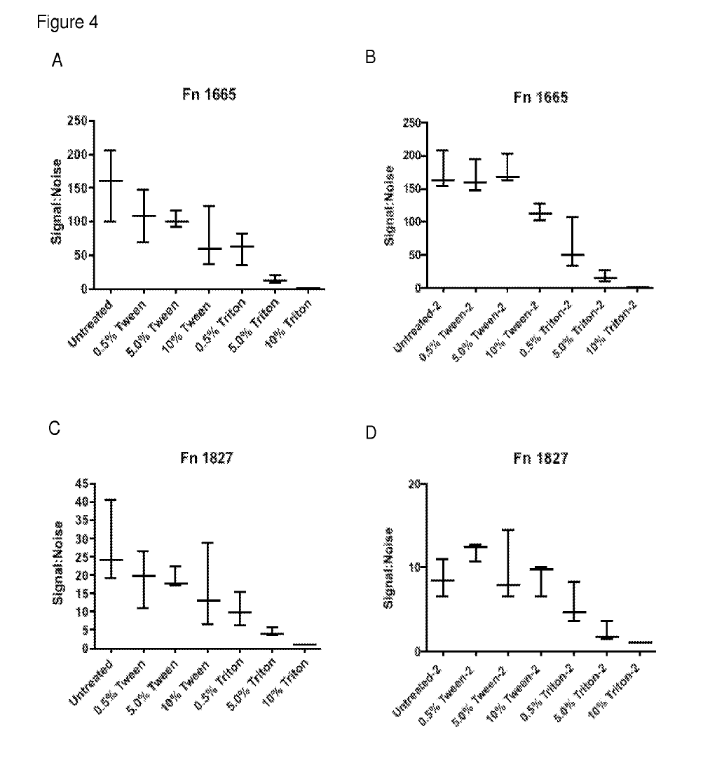

Signal to noise ratios were calculated for signature ion species (1665, 1827 m/z) by FlexAnalysis (Bruker Billerica, Mass.) from the extracted lipid A preparations and the results are presented in FIGS. 4A-4D. Each graph point is the average of triplicate extractions from a single growth tube. Left and right panels are from duplicate growth tubes. For F. novicida, Tween had no deleterious effect on Signal:Noise ratio, while Triton X-100 caused a sharp decrease in Signal:Noise ratio.

### Example 2C—Microwave Extraction

A culture of E. coli strain DH5α (ATCC, Manassas, Va.) was pelleted through centrifugation at 5,000×g for 5 minutes. The pelleted cells were resuspended in acetate buffer at an acidic pH (3-5) containing proteinase K (60 ug/ml). Portions of the bacterial slurry were variously supplemented with Tween-80 (0.5%, 5%, 10%) or Triton X-100 (0.5%, 5%, 10%) and incubated for 30 minutes at 37° C. while gently shaken on a rotating platform. A further portion of the slurry was also gently shaken for 30 minutes at 37° C., but in the absence of any added surfactant.

The slurries were then lysed in a microwave reaction device (Discovery System, CEM Corp., Mathews, N.C.) for 5 minutes, at a microwave wattage of 50 W and a temperature of 58° C. The lysates were subsequently incubated at 100° C. for 60 minutes, during which the core sugar glycosidic linkage to lipid A was hydrolyzed. The resulting product was insoluble lipid A in an aqueous solution. Lipid A was collected by centrifugation and methanol (pure?) soluble contaminants were washed away by successive rounds of methanol resuspension and lipid A recovery. Lipid A product was then solubilized in organic solvent (which one?).

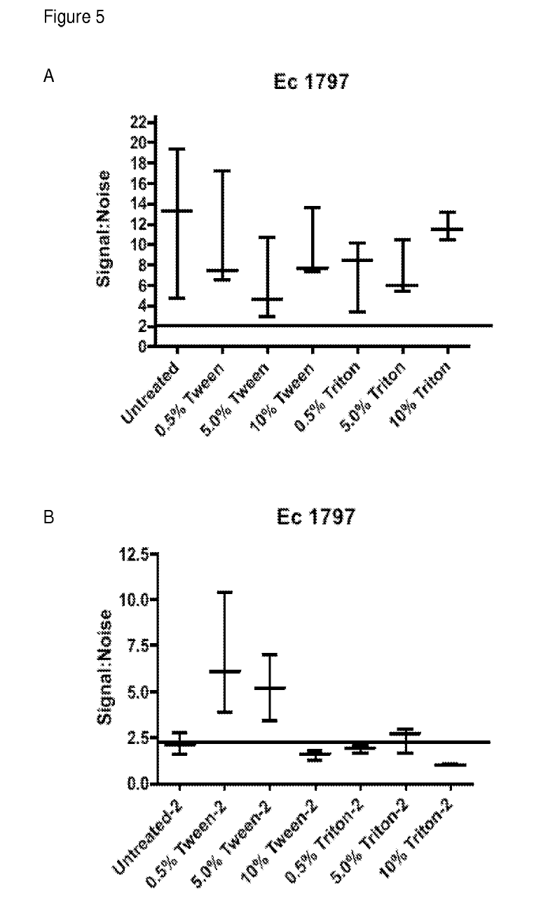

Signal to noise ratios were calculated for signature ion species (1797 m/z) by FlexAnalysis (Bruker Billerica, Mass.) from the extracted lipid A preparations and the results are presented in FIGS. 5A-5B. Each graph point is the average of triplicate extractions from a single growth tube. Left and right panels are from duplicate growth tubes. In this bacterial background, the Tween increased Signal:Noise ratio, while Triton X-100 failed to improve the extraction. Signal:Noise Ratio's below 2 fail to be properly selected in automated peak selection processes.

### Example 2D—Microwave Extraction

A culture of S. Typhimurium strain CS339 (ATCC, Manassas, Va.) was pelleted through centrifugation at 5,000×g for 5 minutes. The pelleted cells were resuspended in acetate buffer at an acidic pH (3-5) containing proteinase K (60 ug/ml). Portions of the bacterial slurry were variously supplemented with Tween-80 (0.5%, 5%, 10%) or Triton X-100 (0.5%, 5%, 10%) and incubated for 30 minutes at 37° C. while gently shaken on a rotating platform. A further portion of the slurry was also gently shaken for 30 minutes at 37° C., but in the absence of any added surfactant.

The slurries were then lysed in a microwave reaction device (Discovery System, CEM Corp., Mathews, N.C.) for 5 minutes, at a microwave wattage of 50 W and a temperature of 58° C. The lysates were subsequently incubated at 100° C. for 60 minutes, during which the core sugar glycosidic linkage to lipid A was hydrolyzed. The resulting product was insoluble lipid A in an aqueous solution. Lipid A was collected by centrifugation and methanol (pure?) soluble contaminants were washed away by successive rounds of methanol resuspension and lipid A recovery. Lipid A product was then solubilized in organic solvent (which one?).

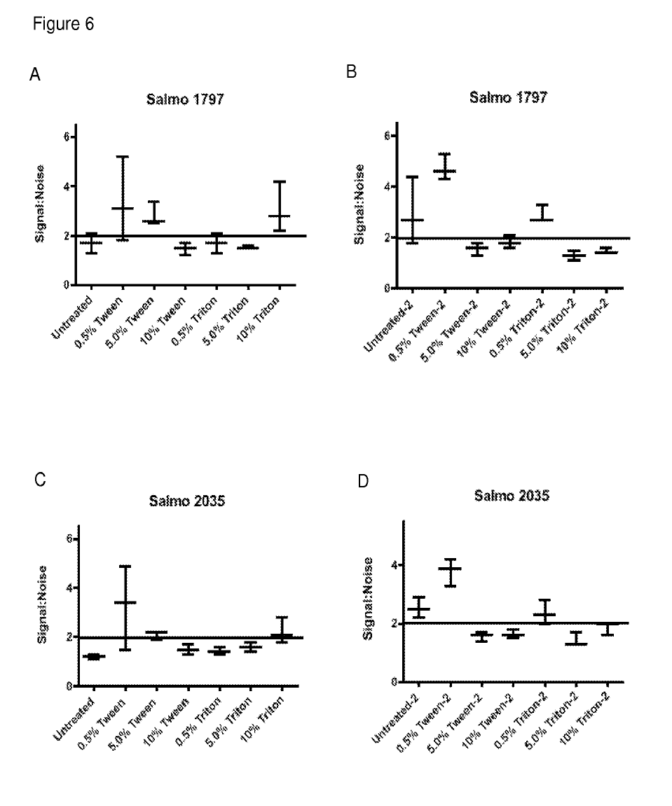

Signal to noise ratios were calculated for signature ion species (1797, 2035 m/z) by FlexAnalysis (Bruker Billerica, Mass.) from the extracted lipid A preparations and the results are presented in FIGS. 6A-6D. Each graph point is the average of triplicate extractions from a single growth tube. Left and right panels are from duplicate growth tubes. For this strain of S. Typhimurium, Tween was able to increase Signal:Noise ratio over untreated samples, while Triton X-100 caused no increase in Signal:Noise ratio. Signal:Noise Ratio's below 2 fail to be properly selected in automated peak selection processes.

### Example 2E—Microwave Extraction

A culture of V. cholerae strain N16861 (O-1 O antigen) (Dr. James Kaper, University of Maryland, Baltimore) was pelleted through centrifugation at 5,000×g for 5 minutes. The pelleted cells were resuspended in acetate buffer at an acidic pH (3-5) containing proteinase K (60 ug/ml). Portions of the bacterial slurry were variously supplemented with Tween-80 (0.5%, 5%, 10%) or Triton X-100 (0.5%, 5%, 10%) and incubated for 30 minutes at 37° C. while gently shaken on a rotating platform. A further portion of the slurry was also gently shaken for 30 minutes at 37° C., but in the absence of any added surfactant.

The slurries were then lysed in a microwave reaction device (Discovery System, CEM Corp., Mathews, N.C.) for 5 minutes, at a microwave wattage of 50 W and a temperature of 58° C. The lysates were subsequently incubated at 100° C. for 60 minutes, during which the core sugar glycosidic linkage to lipid A was hydrolyzed. The resulting product was insoluble lipid A in an aqueous solution. Lipid A was collected by centrifugation and methanol (pure?) soluble contaminants were washed away by successive rounds of methanol resuspension and lipid A recovery. Lipid A product was then solubilized in organic solvent (which one?).

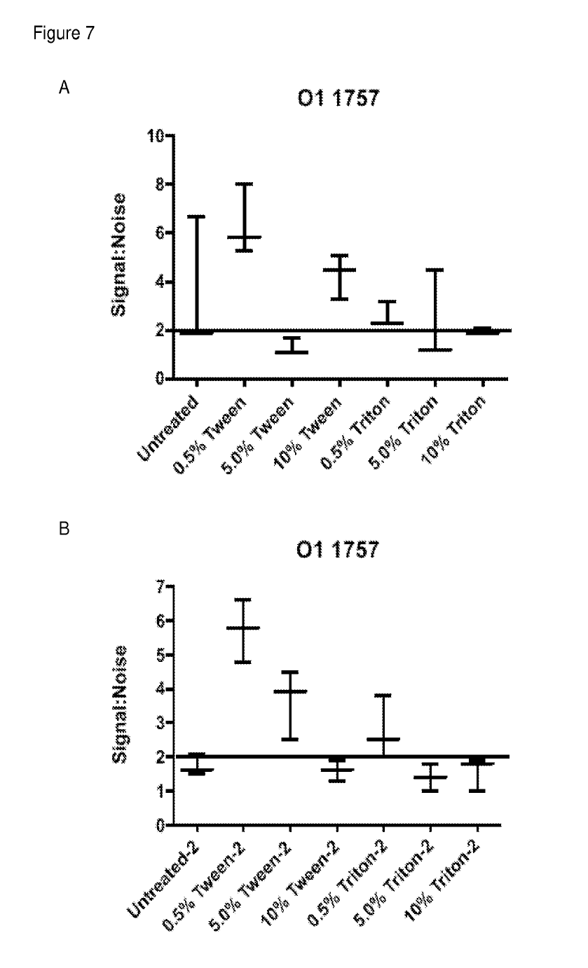

Signal to noise ratios were calculated for signature ion species (1757 m/z) by FlexAnalysis (Bruker Billerica, Mass.) from the extracted lipid A preparations and the results are presented in FIGS. 7A-7B. Each graph point is the average of triplicate extractions from a single growth tube. Left and right panels are from duplicate growth tubes. For this strain of V. cholerae, Tween was able to increase Signal:Noise ratio over untreated samples, while Triton X-100 caused no increase in Signal:Noise ratio. Signal:Noise Ratio's below 2 fail to be properly selected in automated peak selection processes.

### Example 2F—Microwave Extraction

A culture of V. cholerae strain Argentina O-139 (Dr. James Kaper, University of Maryland, Baltimore) was pelleted through centrifugation at 5,000×g for 5 minutes. The pelleted cells were resuspended in acetate buffer at an acidic pH (3-5) containing proteinase K (60 ug/ml). Portions of the bacterial slurry were variously supplemented with Tween-80 (0.5%, 5%, 10%) or Triton X-100 (0.5%, 5%, 10%) and incubated for 30 minutes at 37° C. while gently shaken on a rotating platform. A further portion of the slurry was also gently shaken for 30 minutes at 37° C., but in the absence of any added surfactant.

The slurries were then lysed in a microwave reaction device (Discovery System, CEM Corp., Mathews, N.C.) for 5 minutes, at a microwave wattage of 50 W and a temperature of 58° C. The lysates were subsequently incubated at 100° C. for 60 minutes, during which the core sugar glycosidic linkage to lipid A was hydrolyzed. The resulting product was insoluble lipid A in an aqueous solution. Lipid A was collected by centrifugation and methanol (pure?) soluble contaminants were washed away by successive rounds of methanol resuspension and lipid A recovery. Lipid A product was then solubilized in organic solvent (which one?).

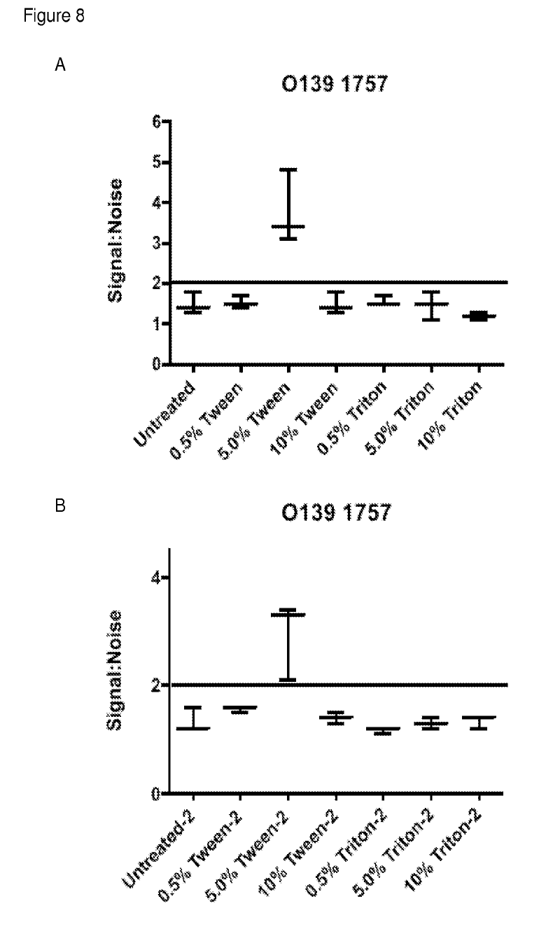

Signal to noise ratios were calculated for signature ion species (1757 m/z) by FlexAnalysis (Bruker Billerica, Mass.) from the extracted lipid A preparations and the results are presented in FIGS. 8A-8B. Each graph point is the average of triplicate extractions from a single growth tube. Left and right panels are from duplicate growth tubes. For this strain of V. cholerae, Tween was able to increase Signal:Noise ratio over untreated samples, while Triton X-100 caused no increase in Signal:Noise ratio. This highlights that the O-antigen of V. cholerae has no effect on the beneficial effect of Tween. Signal:Noise Ratio's below 2 fail to be properly selected in automated peak selection processes.

### Example 2G—Microwave Extraction

A culture of A. baumanii strain AC1C4 (Dr. Yohei Doi, University of Pittsburgh) was pelleted through centrifugation at 5,000×g for 5 minutes. The pelleted cells were resuspended in acetate buffer at an acidic pH (3-5) containing proteinase K (60 ug/ml). Portions of the bacterial slurry were variously supplemented with Tween-80 (0.5%, 5%, 10%) or Triton X-100 (0.5%, 5%, 10%) and incubated for 30 minutes at 37° C. while gently shaken on a rotating platform. A further portion of the slurry was also gently shaken for 30 minutes at 37° C., but in the absence of any added surfactant.

The slurries were then lysed in a microwave reaction device (Discovery System, CEM Corp., Mathews, N.C.) for 5 minutes, at a microwave wattage of 50 W and a temperature of 58° C. The lysates were subsequently incubated at 100° C. for 60 minutes, during which the core sugar glycosidic linkage to lipid A was hydrolyzed. The resulting product was insoluble lipid A in an aqueous solution. Lipid A was collected by centrifugation and methanol (pure?) soluble contaminants were washed away by successive rounds of methanol resuspension and lipid A recovery. Lipid A product was then solubilized in organic solvent (which one?).

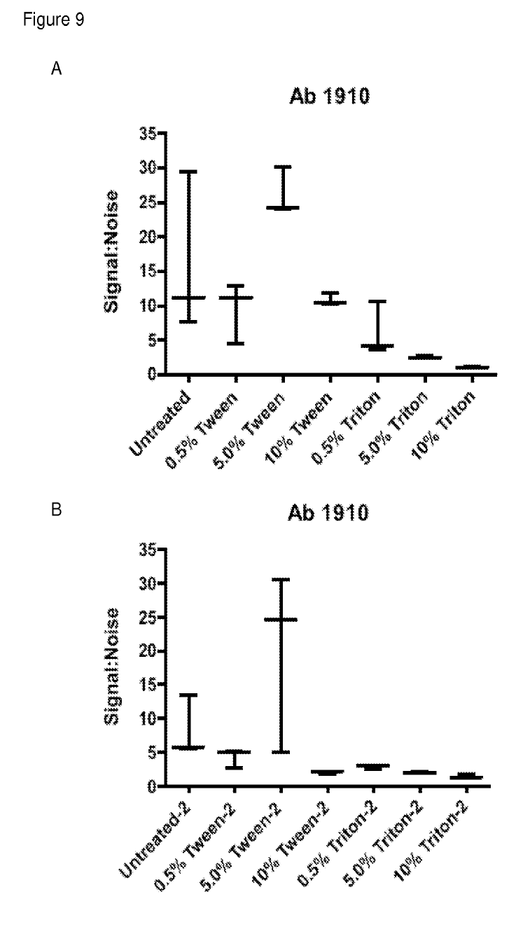

Signal to noise ratios were calculated for signature ion species (1910 m/z) by FlexAnalysis (Bruker Billerica, Mass.) from the extracted lipid A preparations and the results are presented in FIGS. 9A-9B. Each graph point is the average of triplicate extractions from a single growth tube. Left and right panels are from duplicate growth tubes. For this strain of A. baumanii, Tween was able to increase Signal:Noise ratio over untreated samples, while Triton X-100 caused no increase in Signal:Noise ratio. This highlights that even large hepta-acylated species of lipid A can be detected and improved using Tween.

While the invention has been described with reference to certain particular embodiments thereof, those skilled in the art will appreciate that various modifications may be made without departing from the spirit and scope of the invention. The scope of the appended claims is not to be limited to the specific embodiments described.

What is claimed is:

1. A method of obtaining lipids from a microbe comprising (a) mixing microbial cells with a surfactant to form a suspension, and (b) extracting lipids from the suspension using a lysing agent.

2. A method of obtaining lipids from a microbe comprising (a) mixing microbial cells with a surfactant to form a suspension, and (b) extracting lipids from the suspension using an ammonium-isobutyric acid lysing agent.

3. The method of claim 1 or 2, wherein step (a) further comprises one or more of: (i) incubating the suspension for a period of time of between about 1 and 60 minutes, (ii) incubating the suspension at a temperature of between about 25° C. and 45° C., and (iii) shaking the suspension on a rotating platform set at between about 50 and 200 rpm.

4. The method of claim 3, wherein step (a) further comprises (i) and (ii), or (i) and (iii), or (ii) and (iii), or each of (i), (ii) and (iii).

5. The method of claim 3, wherein the suspension is incubated for about 30 minutes.

6. The method of claim 3, wherein the temperature is about 37° C.

7. The method of claim 3, wherein the suspension is shaken on a rotating platform set at about 125 rpm.

8. The method of claim 1 or 2, wherein step (b) further comprises one or more of: (i) harvesting microbial cells from the suspension of (a), and (ii) treating the microbial cells from the suspension of (a) with the lysing agent under conditions of a temperature of between about 80° C. and 120° C. for a period of time of about 10 to 120 minutes, followed by centrifugation of the treated cells and harvesting of the supernatant.

9. The method of claim 8, wherein step (b) further comprises both (i) and (ii).

10. The method of claim 8, wherein the microbial cells in (ii) are treated under conditions of a temperature of between about 100° C. for a period of time of about 60 minutes.

11. The method of claim 8, wherein the harvested supernatant in (ii) is lyophilized to form a powder, the powder is washed with a first solvent, and the powder is extracted with a second solvent.

12. The method of claim 11, wherein the first solvent is methanol, and the second solvent is a mixture of chloroform, methanol and water

13. A method of obtaining lipids from a microbe comprising:
(a) mixing microbial cells with a surfactant to form a suspension, wherein the suspension is incubated for a period of time of between about 1 and 60 minutes, at a temperature of between about 25° C. and 45° C., while shaking on a rotating platform set at between about 50 and 200 rpm, and
(b) extracting lipids from the suspension of (a) using an ammonium-isobutyric acid lysing agent, wherein the microbial cells from the suspension are harvested and treated with a mixture of ammonia hydroxide and isobutyric acid under a temperature of between about 80° C. and 120° C. for a period of time of about 10 to 120 minutes, followed by centrifugation of the treated cells, harvesting of supernatant, lyophilization of the supernatant to form a powder, washing the powder with a first solvent, and extracting the powder with a second solvent.

14. The method of claim 13, wherein the mixture of ammonia hydroxide and isobutyric acid is a mixture of 1M ammonia hydroxide and isobutyric acid in a ratio of about 1:5 to 5:1 (v/v).

15. The method of claim 13, wherein the mixture of ammonia hydroxide and isobutyric acid is a mixture of 1M ammonia hydroxide and isobutyric acid in a ratio of about 3:5 (v/v).

16. The method of claim 13, wherein the first solvent is methanol, and the second solvent is a mixture of chloroform, methanol and water.

17. A method of obtaining lipids from a microbe comprising:
(a) mixing microbial cells with a surfactant to form a suspension, wherein the surfactant is Tween-80 (5%, v/v), the suspension is incubated for a period of time of about 30 minutes, at a temperature of about 37° C., while shaking on a rotating platform set at about 125 rpm, and
(b) extracting lipids from the suspension of (a) using an ammonium-isobutyric acid lysing agent, wherein the microbial cells from the suspension are harvested and treated with a mixture of ammonia hydroxide and isobutyric acid (3:5, v/v) under a temperature of about 100° C. for a period of time of about 60 minutes, followed by centrifugation of the treated cells, harvesting of the supernatant, lyophilization of the supernatant to form a powder, washing the powder with methanol, and extracting the powder with a mixture (3:1.5:0.25, v:v:v) of chloroform, methanol and water.

18. A method of obtaining lipids from a microbe comprising (a) mixing microbial cells with (i) a surfactant and (ii) a lysing agent to form a suspension, and (b) extracting lipids from the suspension.

19. A method of obtaining lipids from a microbe comprising (a) mixing microbial cells with (i) a surfactant and (ii) an ammonium-isobutyric acid lysing agent to form a suspension, and (b) extracting lipids from the suspension.

20. The method of claim 18 or 19, wherein step (a) further comprises mixing the suspension under conditions of a temperature of between about 80° C. and 120° C. for a period of time of about 10 to 120 minutes.

21. The method of claim 20, wherein the suspension is mixed under conditions of a temperature of about 100° C. for a period of time of about 60 minutes.

22. The method of claim 18 or 19, wherein step (b) further comprises centrifugation of the suspension, harvesting of supernatant, lyophilization of the supernatant to form a powder, washing the powder with a first solvent, and extracting the powder with a second solvent.

23. The method of claim 22, wherein the first solvent is methanol, and the second solvent is a mixture of chloroform, methanol and water.

24. A method of obtaining lipids from a microbe comprising:
(a) mixing microbial cells with (i) a surfactant and (ii) an ammonium-isobutyric acid lysing agent to form a suspension, wherein the suspension is incubated under conditions of a temperature of between about 80° C. and 120° C. for a period of time of about 10 to 120 minutes, and
(b) extracting lipids from the suspension of (a) by centrifugation of the suspension, harvesting of supernatant, lyophilization of the supernatant to form a powder, washing the powder with a first solvent, and extracting the powder with a second solvent.

25. The method of claim 23, wherein the first solvent is methanol, and the second solvent is a mixture of chloroform, methanol and water.

26. A method of obtaining lipids from a microbe comprising:
(a) mixing microbial cells with (i) Tween-80 (5%, v/v) and (ii) a mixture (3:5, v/v) of ammonia hydroxide and isobutyric acid as a lysing agent to form a suspension, wherein the suspension is incubated under conditions of a temperature of about 100° C. for a period of time of about 60 minutes, and
(b) extracting lipids from the suspension of (a) by centrifugation of the suspension, harvesting of supernatant, lyophilization of the supernatant to form a powder, washing the powder with methanol, and extracting the powder with a mixture (3:1.5:0.25, v:v:v) of chloroform, methanol and water.

27. A method of obtaining lipids from a microbe comprising
(a) mixing microbial cells with (i) a surfactant and (ii) a protease to form a suspension,
(b) lysing the microbial suspension of (a) with a microwave reaction device, and
(c) extracting lipids from the suspension of (b).

28. The method of claim 26, wherein the suspension of (a) further comprises (iii) a polysaccharidase.

29. The method of claim 26, wherein the suspension of (a) is in an acetate buffer with a pH ranging from about 3 to 5.

30. The method of claim 26, wherein the protease is proteinase K.

31. The method of claim 26, wherein the lysing of (b) comprises a microwave wattage setting of between about 25 to 250 W and a temperature of between about 25° C. to 110° C. for a time of between about 5 to 20 minutes.

32. The method of claim 26, wherein the extracting of (c) comprises one or more of:
(i) incubating the lysed microbial suspension of (b) at a temperature of between about 80° C. and 120° C. for a period of time of about 30 to 120 minutes, (ii) centrifugation to recover lipids, and (iii) solvent extraction to remove contaminants.

33. The method of claim 31, wherein the extracting of (c) comprises (i) and (ii), or (ii) and (iii), or (i) and (iii), or each of (i), (ii) and (iii).

34. The method of claim 32, wherein the solvent is methanol.

35. A method of obtaining lipids from a microbe comprising
(a) mixing microbial cells with (i) a surfactant and (ii) a protease in an acetate buffer (pH 3-5) to form a suspension,
(b) lysing the microbial suspension of (a) with a microwave reaction device under conditions of between about 25 to 250 W, between about 25° C. to 110° C., for about 5 to 20 minutes, and
(c) extracting lipids from the suspension of (b) by incubating the lysed microbial suspension of (b) at 100° C. for about 30-120 minutes, centrifugation to recover lipids, and methanol extraction to remove contaminants.

36. The method of claim 34, wherein the suspension of (a) further comprises (iii) a polysaccharidase.

37. The method of claim 34, wherein the protease is proteinase K.

38. The method of anyone of claims 1, 2, 13, 17-19, 24, 26, 27 and 35, wherein the lipid that is obtained is lipid A.

39. The method of anyone of claims 1, 2, 13, 17-19, 24, 26, 27 and 35, wherein the suspension of (a) comprises between about 0.5 to 10% (v/v) of the surfactant.

40. The method of anyone of claims 1, 2, 13, 17-19, 24, 26, 27 and 35, wherein the suspension of (a) comprises about 5% (v/v) of the surfactant.

41. The method of anyone of claims 1, 2, 13, 17-19, 24, 26, 27 and 35, wherein the surfactant is a non-ionic surfactant.

42. The method of anyone of claims 1, 2, 13, 17-19, 24, 26, 27 and 35, wherein the surfactant is Tween-80.

43. The method of anyone of claims 1, 2, 13, 17-19, 24 and 26, wherein the lysing agent is present in a concentration of between about 75 to 99.9% (v/v) of the suspension.

44. The method of anyone of claims 1, 2, 13, 17-19, 24 and 26, wherein the lysing agent is a mixture of 1M ammonia hydroxide and isobutyric acid in a ratio of about 3:5 (v/v).

45. The method of anyone of claims 1, 2, 13, 17-19, 24, 26, 27 and 35, wherein the microbe is a bacterium, a fungus, or a mixture of both.

46. The method of anyone of claims 1, 2, 13, 17-19, 24, 26, 27 and 35, wherein the microbe is a gram-negative bacterium or a gram-positive bacterium.
